(19) United States
(12) Patent Application Publication
(10) Pub. No.: US 2023/0166723 A1
(43) Pub. Date: Jun. 1, 2023

(54) PHYSICAL FUNCTION INSPECTION DEVICE, PHYSICAL FUNCTION INSPECTION METHOD, AND STORAGE MEDIUM FOR PHYSICAL FUNCTION INSPECTION

(71) Applicant: TOYOTA JIDOSHA KABUSHIKI KAISHA, Toyota-shi (JP)

(72) Inventors: Ryo MURAKAMI, Susono-shi (JP); Shinnosuke SHIMOKAWA, Susono-shi (JP); Junichi MORI, Nagakute-shi (JP); Sokfan YEE, Toyota-shi (JP); Kensaku SHIBATA, Toyota-shi (JP); Yuta MANIWA, Susono-shi (JP)

(21) Appl. No.: 18/047,315

(22) Filed: Oct. 18, 2022

(30) Foreign Application Priority Data
Nov. 26, 2021 (JP) 2021-192075

(51) Int. Cl. B60W 30/02; G06V 20/59

(52) U.S. Cl. CPC B60W 30/025; G06V 20/59; B60W 2300/10; B60W 2720/106; B60W 2420/42; B60W 2540/00

(57) ABSTRACT

A physical function inspection device includes a target person selection unit that selects a target person for physical function inspection from passengers of a vehicle, a behavior detection unit that detects the behavior of the target person when the vehicle is traveling, and an evaluation unit that evaluates the physical function of the target person based on the behavior of the target person.

### CROSS-REFERENCE TO RELATED APPLICATION

This application claims priority to Japanese Patent Application No. 2021-192075 filed on Nov. 26, 2021, incorporated herein by reference in its entirety.

### BACKGROUND

### 1. Technical Field

The present disclosure relates to a physical function inspection device, a physical function inspection method, and a storage medium for physical function inspection.

### 2. Description of Related Art

Japanese Unexamined Patent Application Publication No. 2020-003936 describes that a fall risk of a passenger is determined based on attribute information of the passenger of a vehicle, and traveling of the vehicle is restricted according to the fall risk.

### SUMMARY

However, the attribute information of the passenger may not accurately reflect the fall risk of the passenger. In addition, passengers of a vehicle such as a bus often have time to spare while riding, and there is a need to effectively utilize the riding time.

The present disclosure uses the riding time to inspect the physical function of the passenger of the vehicle.

The gist of the present disclosure is as follows.

A physical function inspection device according to a first aspect of the present disclosure includes a target person selection unit configured to select a target person for physical function inspection from passengers of a vehicle, a behavior detection unit configured to detect behavior of the target person when the vehicle is traveling, and an evaluation unit configured to evaluate a physical function of the target person based on the behavior of the target person.

In the first aspect, the behavior detection unit may detect behaviors of the passengers based on an output of a load sensor provided in the vehicle.

In the first aspect, the load sensor may be provided on a seating surface of a seat of the vehicle.

In the first aspect, the load sensor may be provided on a strap of the vehicle.

In the first aspect, the load sensor may be provided on a floor of the vehicle.

In the first aspect, the behavior detection unit may detect the behavior of the target person based on an image generated by an in-vehicle camera provided in the vehicle.

In the first aspect, the physical function inspection device may further include a vehicle control unit that controls operation of the vehicle. The vehicle control unit may change the shaking of the vehicle when the physical function inspection of the target person is performed according to the behavior of the target person or an input by the target person.

In the first aspect, the vehicle control unit may control the acceleration and deceleration of the vehicle, and change the shaking of the vehicle by changing an upper limit of the acceleration and deceleration of the vehicle.

In the first aspect, the vehicle control unit may change the shaking of the vehicle by changing a damping force generated by a variable damping force damper provided in the vehicle.

In the first aspect, the physical function inspection device may further include a notification unit that notifies the passenger of information regarding the physical function inspection.

In the first aspect, the notification unit may notify the target person of the evaluation result of the physical function.

In the first aspect, the notification unit may notify the passenger of the target person.

In the first aspect, the notification unit may notify the target person of a start of the physical function inspection.

A physical function inspection method according to a second aspect of the present disclosure is executed by a computer. The method includes selecting a target person for physical function inspection from passengers of a vehicle, detecting behavior of the target person when the vehicle is traveling, and evaluating a physical function of the target person based on the behavior of the target person.

A storage medium that stores a computer program for physical function inspection according to a third aspect of the present disclosure causes a computer to execute selecting a target person for physical function inspection from passengers of a vehicle, detecting behavior of the target person when the vehicle is traveling, and evaluating a physical function of the target person based on the behavior of the target person.

With each aspect of the present disclosure, the physical function of the passenger of the vehicle can be inspected by using the riding time.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram of a vehicle control system including a physical function inspection device according to a first embodiment of the present disclosure;

FIG. 2 is a diagram illustrating an example of a vehicle provided with the vehicle control system;

FIG. 3 is a diagram schematically illustrating the inside of the vehicle;

FIG. 4 is a functional block diagram of a processor of an ECU according to the first embodiment;

FIG. 5 is a flowchart illustrating a control routine of a physical function inspection process according to the first embodiment;

FIG. 6 is a schematic configuration diagram of a vehicle control system including a physical function inspection device according to a second embodiment of the present disclosure;

FIG. 7 is a functional block diagram of a processor of an ECU according to the second embodiment;

FIG. 8 is a flowchart illustrating a control routine of a physical function inspection process in the second embodiment;

FIG. 9 is a schematic configuration diagram of a physical function inspection system including a physical function inspection device according to a third embodiment of the present disclosure; and

FIG. 10 is a diagram schematically illustrating a configuration of a server.

### DETAILED DESCRIPTION OF EMBODIMENTS

Hereinafter, embodiments of the present disclosure will be described in detail with reference to the drawings. In the following description, similar components are given the same reference numbers.

### First Embodiment

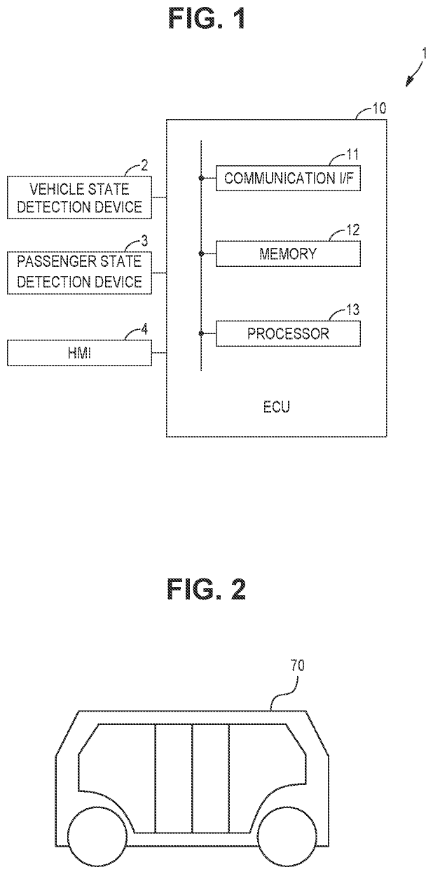

First, a first embodiment of the present disclosure will be described with reference to FIGS. 1 to 5. FIG. 1 is a schematic configuration diagram of a vehicle control system 1 including a physical function inspection device according to the first embodiment of the present disclosure. In this embodiment, the vehicle control system 1 is provided in a vehicle 70 as illustrated in FIG. 2. The vehicle 70 is a bus capable of transporting a plurality of passengers. For example, the vehicle 70 may be a route bus in which an operation plan (operation route and operation schedule) of the vehicle 70 is predetermined, or a demand-type bus of which the operation plan is determined according to reservation information and the like.

As illustrated in FIG. 1, the vehicle control system 1 includes a vehicle state detection device 2, a passenger state detection device 3, a human machine interface (HMI) 4, and an electronic control unit (ECU) 10. The vehicle state detection device 2, the passenger state detection device 3, and the HMI 4 are electrically connected to the ECU 10 via an in-vehicle network or the like conforming to a standard such as a controller area network (CAN).

The vehicle state detection device 2 is provided in the vehicle 70 and detects a state quantity of the vehicle 70. The vehicle state detection device 2 includes, for example, a GNSS receiver that detects the current position (for example, the latitude and longitude of the vehicle 70) of the vehicle 70, a vehicle speed sensor that detects the speed of the vehicle 70, an acceleration sensor that detects the acceleration of the vehicle 70, and the like. The output of the vehicle state detection device 2, that is, the state quantity of the vehicle 70 detected by the vehicle state detection device 2, is transmitted to the ECU 10.

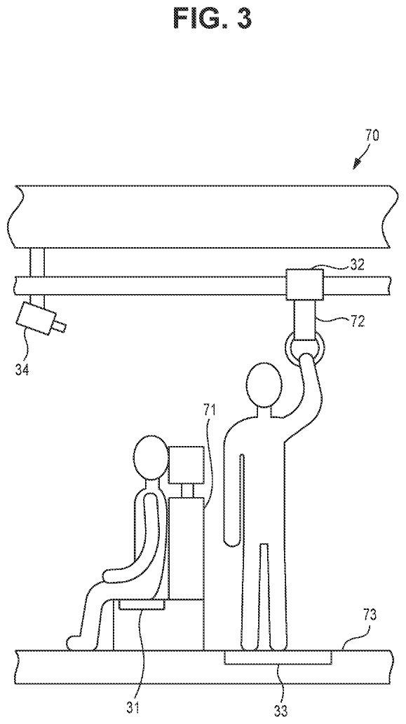

The passenger state detection device 3 is provided in the vehicle 70 and detects the passenger state. FIG. 3 is a diagram schematically illustrating the inside of the vehicle 70. Although the figure shows one seat 71 and one strap 72, the vehicle 70 has a plurality of seats 71 and a plurality of straps 72.

In the present embodiment, the passenger state detection device 3 includes a first load sensor 31, a second load sensor 32, a third load sensor 33, and an in-vehicle camera 34. The first load sensor 31 to the third load sensor 33 each detect the loads of the passengers of the vehicle 70. The outputs of the first load sensor 31 to the third load sensor 33, that is, the loads of the passengers detected by the first load sensor 31 to the third load sensor 33 are transmitted to the ECU 10.

The first load sensor 31 is provided on a seating surface of the seat 71, and detects the load acting on the seating surface, that is, the load of the passenger seated on the seat 71. The first load sensor 31 may be provided on only some (for example, one) of the plurality of seats 71.

The second load sensor 32 is provided on the strap 72 and detects the load acting on the strap 72, that is, the load of the passenger holding the strap 72. The second load sensor 32 may be provided on only some (for example, one) of the plurality of straps 72.

The third load sensor 33 is provided on a floor 73 of the vehicle 70, and detects the load acting on the floor 73, that is, the load of the passenger standing on the floor 73. The third load sensor 33 is arranged so as to be located under both feet of the passenger holding the strap 72. The third load sensor 33 may be provided on the floor under only some (for example, one) of the plurality of straps 72. Further, a mark (for example, a mark in the shape of both feet) indicating the position of the third load sensor 33 may be drawn on the floor 73.

The in-vehicle camera 34 photographs the inside of the vehicle 70 to generate an image. The in-vehicle camera 34 is provided on a ceiling 74 or the like of the vehicle 70 so as to photograph the passengers of the vehicle 70. The output of the in-vehicle camera 34, that is, the image generated by the in-vehicle camera 34 is transmitted to the ECU 10. The in-vehicle camera 34 may be a plurality of cameras arranged at different positions in the vehicle 70.

The HMI 4 is installed in the vehicle 70 and exchanges information between the vehicle 70 and the passengers of the vehicle 70. The HMI 4 has an output unit (for example, a display, a speaker, and the like) that outputs information to the passenger of the vehicle 70, and an input unit (for example, a touch panel, an operation button, an operation switch, a microphone, and the like) through which information is input by the passenger of the vehicle 70. The output of the ECU 10 is notified to the passenger of the vehicle 70 via the HMI 4, and the input from the passenger of the vehicle 70 is transmitted to the ECU 10 via the HMI 4. The HMI 4 is an example of an input device, an output device, or an input and output device. The mobile terminal (a smartphone, a tablet terminal, and the like) of the passenger of the vehicle 70 may be connected to the ECU 10 by wire or wirelessly so as to be able to communicate with the ECU 10 and function as the HMI 4.

The ECU 10 executes various controls of the vehicle 70. As illustrated in FIG. 1, the ECU 10 includes a communication interface 11, a memory 12, and a processor 13. The communication interface 11 and the memory 12 are connected to the processor 13 via a signal line. In this embodiment, one ECU 10 is provided, but a plurality of ECUs may be provided for each function.

The communication interface 11 has an interface circuit for connecting the ECU 10 to the in-vehicle network. The ECU 10 is connected to another vehicle-mounted device via the communication interface 11. The communication interface 11 is an example of a communication unit of the ECU 10.

The memory 12 has, for example, a volatile semiconductor memory and a non-volatile semiconductor memory. The memory 12 stores computer programs, data, and the like used when various processes are executed by the processor 13.

The processor 13 has one or a plurality of central processing units (CPUs) and peripheral circuits thereof. The processor 13 may further have an arithmetic circuit such as a logical operation unit or a numerical operation unit.

Further, the passengers of the vehicle 70 such as the bus illustrated in FIG. 2 often have time to spare while riding. Therefore, in this embodiment, the physical function inspection of the passenger in the vehicle 70 is carried out by the ECU 10 of the vehicle 70 while the vehicle 70 is traveling. That is, the ECU 10 functions as a physical function inspection device for inspecting the physical functions of the passengers of the vehicle 70.

While the vehicle 70 is traveling, the vehicle 70 shakes, and the passengers of the vehicle 70 try to maintain their posture against the shaking. In this case, the higher the physical function, the easier it is to maintain the posture, and the less the balance is lost. That is, the behavior of the passenger of the vehicle 70 when the vehicle 70 is traveling has a correlation with the physical function of the passenger. Therefore, the characteristics of the vehicle 70 can be used to inspect the physical function of the passenger of the vehicle 70 while the vehicle 70 is traveling.

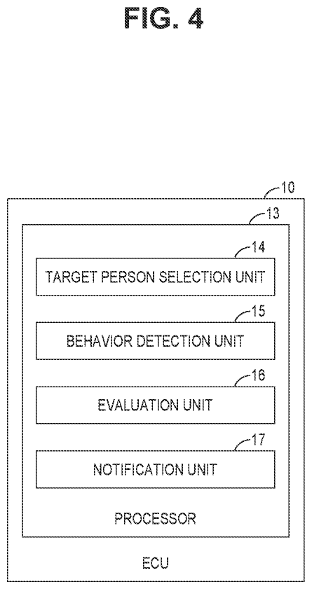

FIG. 4 is a functional block diagram of the processor 13 of the ECU 10 according to the first embodiment. In this embodiment, the processor 13 has a target person selection unit 14, a behavior detection unit 15, an evaluation unit 16, and a notification unit 17. The target person selection unit 14, the behavior detection unit 15, the evaluation unit 16, and the notification unit 17 are functional modules realized by the processor 13 of the ECU 10 executing the computer program stored in the memory 12 of the ECU 10. Each of these functional modules may be realized by a dedicated arithmetic circuit provided in the processor 13.

The target person selection unit 14 selects a target person for physical function inspection (hereinafter, also simply referred to as “target person”) from the passengers of the vehicle 70. Next, the behavior detection unit 15 detects the behavior of the target person when the vehicle 70 is traveling, and the evaluation unit 16 evaluates the physical function of the target person based on the behavior of the target person. This makes it possible to inspect the physical function of the passenger of the vehicle 70 using the riding time.

The notification unit 17 notifies the passenger of the information of the physical function inspection. For example, the notification unit 17 notifies the passenger of the target person via the target person selection unit 14. This makes it possible to notify the passengers of the vehicle 70 who the target person is. In addition, the notification unit 17 notifies the target person of the start and end of the physical function inspection. This makes it possible to notify the target person that the physical function inspection is being carried out. In addition, the notification unit 17 notifies the target person of the evaluation result of the physical function obtained by the evaluation unit 16. This allows the passengers of the vehicle 70 to be provided with information regarding their physical function. That is, it is possible to provide the passengers of the vehicle 70 with added value other than movement.

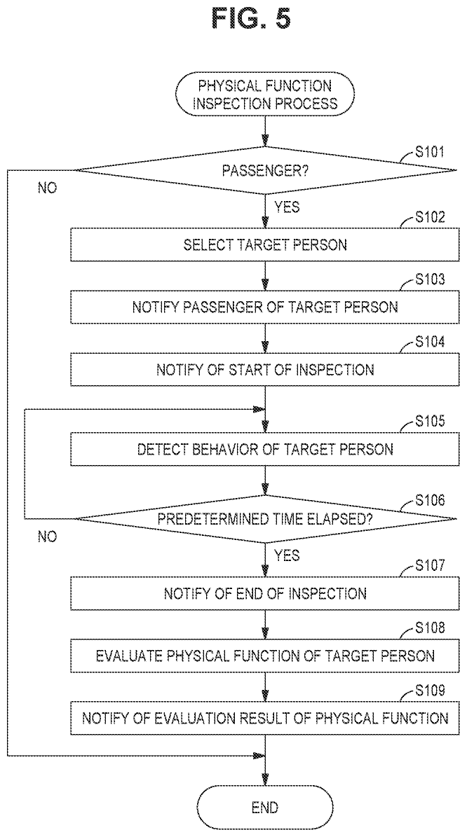

Hereinafter, the control flow of the above-described processing will be described in detail with reference to FIG. 5. FIG. 5 is a flowchart illustrating a control routine of the physical function inspection process according to the first embodiment. This control routine is executed by the processor 13 of the ECU 10 according to the computer program stored in the memory 12 of the ECU 10.

First, in step S101, the target person selection unit 14 determines whether there is a passenger in the vehicle 70. For example, the target person selection unit 14 detects the passenger of the vehicle 70 based on the output of the passenger state detection device 3. When the passenger of the vehicle 70 is detected by the first load sensor 31, it is determined that the passenger is in the seat 71 provided with the first load sensor 31. When the passenger of the vehicle 70 is detected by the second load sensor 32, it is determined that the passenger is under the strap 72 provided with the second load sensor 32. When the passenger of the vehicle 70 is detected by the third load sensor 33, it is determined that the passenger is on the floor 73 provided with the third load sensor 33. The target person selection unit 14 may detect the passenger of the vehicle 70 based on the image generated by the in-vehicle camera 34 by using a known image recognition technique (a machine learning model or the like).

When it is determined in step S101 that there is no passenger, this control routine ends. On the other hand, when it is determined in step S101 that there is a passenger, the control routine proceeds to step S102. In step S102, the target person selection unit 14 selects a target person from the passengers of the vehicle 70. For example, when there is only one passenger, that passenger is selected as the target person. On the other hand, when there is a plurality of passengers, one target person is randomly selected from the plurality of passengers. A plurality of passengers (for example, all passengers) may be selected as the target person. Further, the target person selection unit 14 may select a passenger who desires a physical function inspection via the HMI 4 as a target person.

Then, in step S103, the notification unit 17 notifies the passenger of the target person via the HMI 4 of the vehicle 70. For example, the HMI 4 is provided on the back surface of the seat 71, the strap 72, or the like, and the notification unit 17 indicates to the HMI 4 in the vicinity of the target person that he or she is the target person of the physical function inspection.

Then, in step S104, the notification unit 17 notifies the target person of the start of the physical function inspection. For example, the notification unit 17 indicates to the HMI 4 in the vicinity of the target person that the physical function inspection is to start. When the target person is a passenger seated in the seat 71, the notification unit 17 may instruct the target person to move away from the backrest of the seat 71 via the HMI 4.

Next, in step S105, the behavior detection unit 15 detects the behavior of the target person based on the output of the passenger state detection device 3. That is, the behavior detection unit 15 detects the behavior of the target person based on at least one output of the first load sensor 31 to the third load sensor 33 and the in-vehicle camera 34.

Next, in step S106, the behavior detection unit 15 determines whether a predetermined time (for example, one minute to 10 minutes) has elapsed since the physical function inspection started. The predetermined time corresponds to the inspection time of the physical function. When it is determined that the predetermined time has not elapsed, the control routine returns to step S105. On the other hand, when it is determined that the predetermined time has elapsed, the control routine proceeds to step S107.

In step S107, the notification unit 17 notifies the target person of the end of the physical function inspection. For example, the notification unit 17 indicates to the HMI 4 in the vicinity of the target person that the physical function inspection has been completed.

Then, in step S108, the evaluation unit 16 evaluates the physical function of the target person based on the behavior of the target person detected by the behavior detection unit 15. For example, the evaluation unit 16 evaluates the physical function of the target person by comparing the acceleration of the vehicle 70 detected by the vehicle state detection device 2 (specifically, an accelerometer) with the behavior of the target person detected by the behavior detection unit 15. When the vehicle 70 is accelerating, the acceleration of the vehicle 70 is a positive value, and when the vehicle 70 is decelerating, the acceleration of the vehicle 70 is a negative value.

When the behavior of the target person is detected based on the output of the first load sensor 31, in the evaluation unit 16, the smaller the amount of deviation of the center position of the load acting on the seating surface of the seat 71 with respect to the absolute value of the acceleration of the vehicle 70, the higher the evaluation of the physical function of the target person. When the behavior of the target person is detected based on the output of the second load sensor 32, in the evaluation unit 16, the smaller the load acting on the strap 72 with respect to the absolute value of the acceleration of the vehicle 70, the higher the evaluation of the physical function of the target person. When the behavior of the target person is detected based on the output of the third load sensor 33, in the evaluation unit 16, the smaller the amount of deviation of the center position of the load acting on the floor 73 by both feet of the target person with respect to the absolute value of the acceleration of the vehicle 70, the higher the evaluation of the physical function of the target person. When the behavior of the target person is detected based on the image generated by the in-vehicle camera 34, in the evaluation unit 16, the smaller the amount of movement of the target person obtained by image analysis with respect to the absolute value of the acceleration of the vehicle 70, the higher the evaluation of the physical function of the target person.

The evaluation unit 16 may evaluate the physical function of the target person using an identifier which is pre-trained to output the evaluation (for example, an evaluation value) of the physical function of the target person from the acceleration of the vehicle 70 and the output of the passenger state detection device 3 (at least one of the first load sensor 31 to the third load sensor 33 and the in-vehicle camera 34). In this case, when the in-vehicle camera 34 is used as the passenger state detection device 3, the time series data of the image generated by the in-vehicle camera 34 is input to the identifier. Examples of an identifier include machine learning models such as a neural network, a support vector machine, and a random forest.

Next, in step S109, the notification unit 17 notifies the target person of the evaluation result of the physical function. For example, the notification unit 17 displays the evaluation result of the physical function inspection on the HMI 4 in the vicinity of the target person. In this case, the evaluation result of the physical function may be indicated by, for example, a predetermined evaluation value such as a score, rank, or physiological age. The notification unit 17 may notify the target person of an estimated calorie consumption by the physical function inspection in addition to the evaluation result of the physical function. Further, the notification unit 17 may notify the target person of the evaluation result of the physical function by notifying the target person of information (QR code (registered trademark), URL, or the like) of the storage location of the evaluation result of the physical function. In this case, when the target person accesses the storage location, a health promotion method (for example, recommended exercise) according to the evaluation result of the physical function may be provided to the target person. After step S109, this control routine ends.

In addition, in at least one step of steps S103, S104, S107, and S109, the notification unit 17 may notify the target person with auditory information instead of visual information or in addition to visual information. That is, the notification unit 17 may notify the target person of the information of the physical function inspection by outputting a voice from the HMI 4.

Further, step S107 may be omitted. In this case, the target person can know that the physical function inspection has ended when he or she is notified of the evaluation result of the physical function. Further, steps S103 and S104 may be omitted, and the physical function inspection may be performed without notification. Further, step S109 may be omitted, and instead of notifying the target person of the evaluation result of the physical function, for example, a traveling restriction of the vehicle 70 based on the evaluation result of the physical function may be performed.

### Second Embodiment

A vehicle control system according to a second embodiment is essentially the same as the vehicle control system according to the first embodiment, except for the points described below. Therefore, hereinafter, the second embodiment of the present disclosure will be described focusing on the parts different from those of the first embodiment.

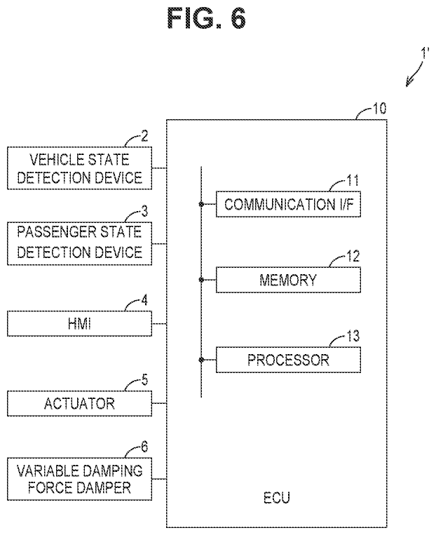

FIG. 6 is a schematic configuration diagram of a vehicle control system 1′ including a physical function inspection device according to the second embodiment of the present disclosure. In the second embodiment, the vehicle control system 1′ also further includes an actuator 5 and a variable damping force damper 6. The actuator 5 and the variable damping force damper 6 are electrically connected to the ECU 10 via an in-vehicle network or the like conforming to a standard such as a controller area network (CAN).

The actuator 5 is provided in the vehicle 70 and operates the vehicle 70. For example, the actuator 5 includes a drive device (for example, at least one of an internal combustion engine and an electric motor) for accelerating the vehicle 70, a brake actuator for decelerating (braking) the vehicle 70, and a steering motor for steering the vehicle 70. The ECU 10 controls the actuator 5 to control the behavior of the vehicle 70. That is, in the second embodiment, the vehicle 70 is an autonomous driving vehicle in which some or all of the acceleration, steering, and deceleration (braking) of the vehicle 70 are automatically executed.

The variable damping force damper 6 is provided in the vehicle 70 together with a suspension spring, and absorbs the vibration of the suspension spring generated by an impact from a road surface. Further, the variable damping force damper 6 can adjust the damping force generated by the variable damping force damper 6 by a known configuration using a solenoid valve. The ECU 10 controls the variable damping force damper 6 to adjust the damping force. The variable damping force damper 6 is also referred to as a variable damping force shock absorber.

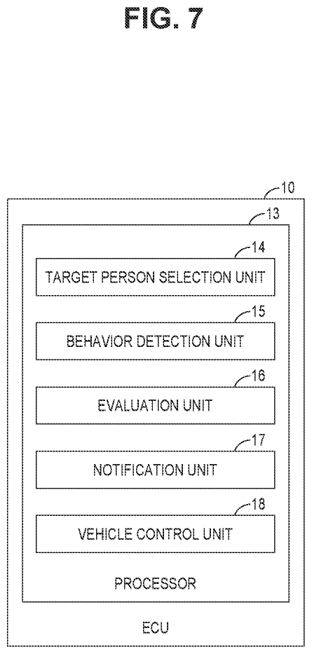

FIG. 7 is a functional block diagram of the processor 13 of the ECU 10 according to the second embodiment. In the second embodiment, the processor 13 has a vehicle control unit 18 in addition to the target person selection unit 14, the behavior detection unit 15, the evaluation unit 16, and the notification unit 17. The target person selection unit 14, the behavior detection unit 15, the evaluation unit 16, the notification unit 17, and the vehicle control unit 18 are functional modules realized by the processor 13 of the ECU 10 executing the computer program stored in the memory 12 of the ECU 10. Each of these functional modules may be realized by a dedicated arithmetic circuit provided in the processor 13.

The vehicle control unit 18 controls the operation of the vehicle 70. For example, the vehicle control unit 18 controls the acceleration and deceleration of the vehicle 70 by using the actuator 5.

As described above, the ECU 10 functioning as a physical function inspection device evaluates the physical function of the passenger based on the behavior of the passenger of the vehicle 70 when the vehicle 70 is traveling. However, the load suitable for inspecting the physical function varies from passenger to passenger of the vehicle 70. In addition, the greater the shaking of the vehicle 70, the more difficult it is for the passengers of the vehicle 70 to maintain their posture.

Therefore, in the second embodiment, the vehicle control unit 18 changes the shaking of the vehicle 70 when the physical function inspection of the target person is carried out according to the behavior of the target person of the physical function inspection or the input by the target person. As a result, an appropriate load can be imposed on the target person, and the physical function of the target person can be inspected more appropriately.

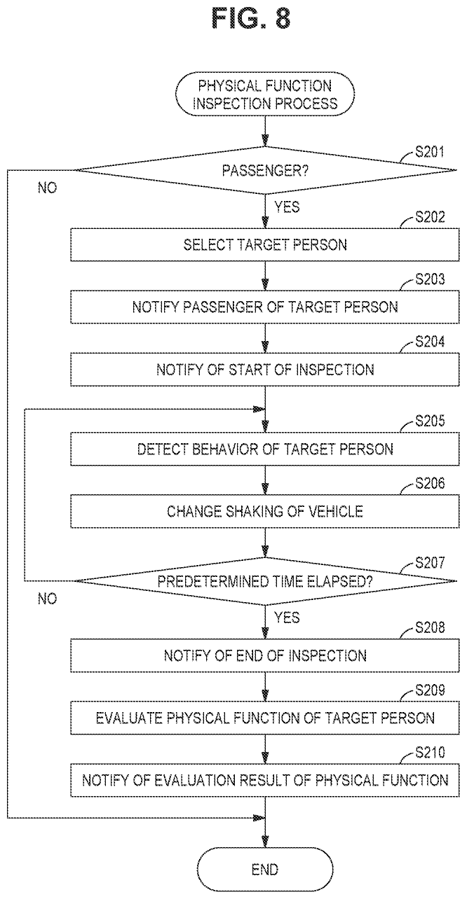

FIG. 8 is a flowchart illustrating a control routine of a physical function inspection process in the second embodiment. This control routine is executed by the processor 13 of the ECU 10 according to the computer program stored in the memory 12 of the ECU 10.

Steps S201 to S205 are executed in the same manner as steps S101 to S105 in FIG. 5. After step S205, in step S206, the vehicle control unit 18 changes the shaking of the vehicle 70 based on the behavior of the target person during the physical function inspection. Specifically, when the stability of the posture of the target person is high, the vehicle control unit 18 increases the shaking of the vehicle 70 as compared with the case where the stability of the posture of the target person is low.

For example, the vehicle control unit 18 changes the degree of shaking of the vehicle 70 by changing the upper limit of the acceleration and deceleration of the vehicle 70. In this case, the higher the upper limit of the acceleration and deceleration of the vehicle 70, the greater the degree of shaking of the vehicle 70. That is, the vehicle control unit 18 increases the upper limit of the acceleration and deceleration of the vehicle 70 when increasing the degree of shaking of the vehicle 70, and decreases the upper limit of the acceleration and deceleration of the vehicle 70 when reducing the shaking of the vehicle 70. Further, the vehicle control unit 18 may change the shaking of the vehicle 70 by changing the damping force generated by the variable damping force damper 6. In this case, the smaller the damping force, the greater the shaking degree of the vehicle 70. That is, the vehicle control unit 18 reduces the damping force when increasing the shaking of the vehicle 70, and increases the damping force when reducing the shaking of the vehicle 70.

The vehicle control unit 18 may change the shaking of the vehicle 70 based on the input by the target person. In this case, the target person inputs a load increase or decrease request or the like into the HMI 4, and the input result is transmitted to the ECU 10. The vehicle control unit 18 increases the shaking of the vehicle 70 when an increase in load is requested, and decreases the shaking of the vehicle 70 when a decrease in load is requested.

After step S206, in step S207, in a similar manner to step S106 of FIG. 5, the behavior detection unit 15 determines whether a predetermined time has elapsed since the physical function inspection started. When it is determined that the predetermined time has not elapsed, step S205 and step S206 are executed again. On the other hand, when it is determined that the predetermined time has elapsed, the control routine proceeds to step S208. Steps S208 to S210 are executed in the same manner as steps S107 to S109 of FIG. 5.

### Third Embodiment

A vehicle control system according to a third embodiment is essentially the same as the vehicle control system according to the first embodiment, except for the points described below. Therefore, the third embodiment of the present disclosure will be described below focusing on the parts different from those of the first embodiment.

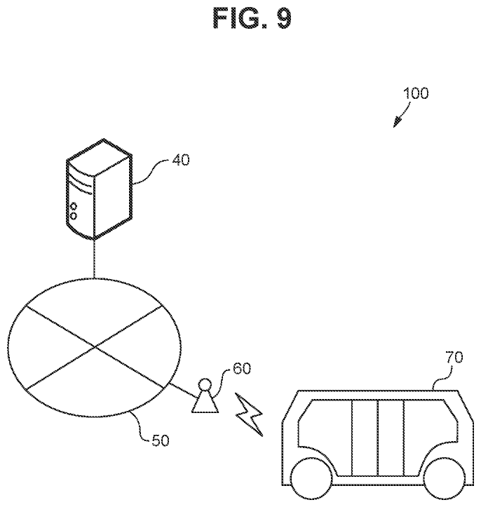

FIG. 9 is a schematic configuration diagram of a physical function inspection system 100 including a physical function inspection device according to the third embodiment of the present disclosure. The physical function inspection system 100 includes a server 40 and the vehicle 70. The server 40 can communicate with the vehicle 70 via a communication network 50 such as a carrier network or an internet network and a radio base station 60. That is, the server 40 can communicate with the vehicle 70 via wide area communication.

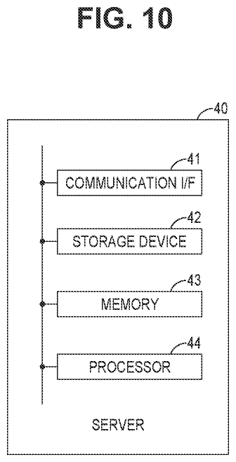

FIG. 10 is a diagram schematically illustrating the configuration of the server 40. The server 40 includes a communication interface 41, a storage device 42, a memory 43, and a processor 44. The communication interface 41, the storage device 42, and the memory 43 are connected to the processor 44 via a signal line. The server 40 may further include an input device such as a keyboard and a mouse, an output device such as a display, and the like. Further, the server 40 may be composed of a plurality of computers.

The communication interface 41 has an interface circuit for connecting the server 40 to the communication network 50. The server 40 communicates with the outside (for example, the vehicle 70) of the server 40 via the communication network 50. The communication interface 41 is an example of a communication unit of the server 40.

The storage device 42 includes, for example, a hard disk drive (HDD), a solid state drive (SSD) or an optical recording medium, and an access device thereof. The storage device 42 stores various data, for example, map information, information (identification information, location information, and the like) on the vehicle 70, a computer program for the processor 44 to execute various processes, and the like. The storage device 42 is an example of a storage unit of the server 40.

The memory 43 has a non-volatile semiconductor memory such as RAM. The memory 43 temporarily stores various data used when various processes are executed by the processor 44, for example. The memory 43 is another example of the storage unit of the server 40.

The processor 44 has one or a plurality of CPUs and peripheral circuits thereof, and executes various processes. The processor 44 may further include other arithmetic circuits such as a logical operation unit, a numerical operation unit, or a graphic processing unit.

In the third embodiment, the server 40 functions as a physical function inspection device instead of the ECU 10, and the processor 44 of the server 40 has the target person selection unit 14, the behavior detection unit 15, the evaluation unit 16, and the notification unit 17. In this case, the target person selection unit 14, the behavior detection unit 15, the evaluation unit 16, and the notification unit 17 are functional modules realized by the processor 44 of the server 40 executing the computer program stored in the storage device 42 of the server 40.

Therefore, in the third embodiment, the control routine of the physical function inspection process of FIG. 5 is executed by the processor 44 of the server 40. In this case, the outputs of the vehicle state detection device 2 and the passenger state detection device 3 are transmitted from the vehicle 70 to the server 40 as necessary, and the server 40 provides notification of the information of the physical function inspection via the ECU 10 of the vehicle 70.

The ECU 10 and the server 40 may function as a physical function inspection device. In this case, for example, the processor 13 of the ECU 10 has the target person selection unit 14, the behavior detection unit 15, and the notification unit 17, and the processor 44 of the server 40 has the evaluation unit 16.

### Other Embodiments

Although the preferred embodiments of the present disclosure are described above, the present disclosure is not limited to these embodiments, and various modifications and changes can be made within the scope of the claims. For example, the vehicle 70 may be a taxi, a private car, or the like.

Further, a computer program for realizing the functions of each part of the processor 13 of the ECU 10 or the processor 44 of the server 40 in the computer may be stored in a recording medium (storage medium) readable by the computer. The recording medium readable by a computer is, for example, a magnetic recording medium, an optical recording medium, or a semiconductor memory.

Further, the above-described embodiments can be implemented in any combination. When the second embodiment and the third embodiment are combined, the control routine of the physical function inspection process of FIG. 8 is executed by the processor 44 of the server 40. In this case, the vehicle control unit 18 of the server 40 changes the shaking of the vehicle 70 via the ECU 10.

What is claimed is:

1. A physical function inspection device comprising:
a target person selection unit configured to select a target person for physical function inspection from passengers of a vehicle;
a behavior detection unit configured to detect behavior of the target person when the vehicle is traveling; and
an evaluation unit configured to evaluate a physical function of the target person based on the behavior of the target person.

2. The physical function inspection device according to claim 1, wherein the behavior detection unit is configured to detect behaviors of the passengers based on an output of a load sensor provided in the vehicle.

3. The physical function inspection device according to claim 2, wherein the load sensor is provided on a seating surface of a seat of the vehicle.

4. The physical function inspection device according to claim 2, wherein the load sensor is provided on a strap of the vehicle.

5. The physical function inspection device according to claim 2, wherein the load sensor is provided on a floor of the vehicle.

6. The physical function inspection device according to claim 1, wherein the behavior detection unit is configured to detect the behavior of the target person based on an image generated by an in-vehicle camera provided in the vehicle.

7. The physical function inspection device according to claim 1, further comprising a vehicle control unit configured to control operation of the vehicle, wherein the vehicle control unit is configured to change a shaking of the vehicle when the physical function inspection of the target person is performed according to the behavior of the target person or an input by the target person.

8. The physical function inspection device according to claim 7, wherein the vehicle control unit is configured to control acceleration and deceleration of the vehicle, and change the shaking of the vehicle by changing an upper limit of acceleration and deceleration of the vehicle.

9. The physical function inspection device according to claim 7, wherein the vehicle control unit is configured to change the shaking of the vehicle by changing a damping force generated by a variable damping force damper provided in the vehicle.

10. The physical function inspection device according to claim 1, further comprising a notification unit configured to notify the passenger of information regarding the physical function inspection.

11. The physical function inspection device according to claim 10, wherein the notification unit is configured to notify the target person of the evaluation result of the physical function.

12. The physical function inspection device according to claim 10, wherein the notification unit is configured to notify the passenger of the target person.

13. The physical function inspection device according to claim 10, wherein the notification unit is configured to notify the target person of a start of the physical function inspection.

14. A physical function inspection method executed by a computer, the physical function inspection method comprising:
selecting a target person for physical function inspection from passengers of a vehicle;
detecting behavior of the target person when the vehicle is traveling; and
evaluating a physical function of the target person based on the behavior of the target person.

15. A non-transitory storage medium that stores a computer program for physical function inspection, the computer program causing a computer to execute:
selecting a target person for physical function inspection from passengers of a vehicle;
detecting behavior of the target person when the vehicle is traveling; and
evaluating a physical function of the target person based on the behavior of the target person.
